(19) United States
(12) Patent Application Publication
(10) Pub. No.: US 2007/0230470 A1
(43) Pub. Date: Oct. 4, 2007

(54) Virtual collapsed backbone network architecture

(75) Inventor: Atul B. Mahamuni, San Jose, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: RedEye Networks, Inc.

(21) Appl. No.: 11/606,714

(22) Filed: Nov. 29, 2006

Related U.S. Application Data
(60) Provisional application No. 60/786,443, filed on Mar. 28, 2006.

(51) Int. Cl. H04L 12/56

(52) U.S. Cl. 370/392; 370/401

(57) ABSTRACT

A system and method for implementing an overlay network architecture called a Virtual Collapsed Backbone (VCB) are described herein. In one embodiment, a VCB provides a framework for consolidating campus network service elements in a centralized fashion, instead of distributing them at the edges of the campus network. End stations create tunnels to a new type of network device called Network Junction Point (NJP) located in the campus network and the NJP steers the traffic through service elements selected based on the traffic steering policy. Other methods and apparatuses are also described.

### RELATED APPLICATIONS

This application claims the benefit of U.S. Patent Provisional Application No. 60/786,443, filed Mar. 28, 2006, the disclosure of which is incorporated herein in its entirety.

### FIELD OF THE INVENTION

The present invention relates generally to computer networking. More particularly, this invention relates to virtual collapsed backbone network architecture.

### BACKGROUND

The general trend in local area networking today is to add more intelligence within the network. There are ample reasons to consider doing this—intrusion detection and prevention, malware and spyware protection, P2P traffic management, compliance monitoring, intellectual property tracking, QoS (quality of service), and just plain old troubleshooting. We refer to these devices as “Service Elements” or SEs. Ideally, the IT managers like to have enough capability at every entry point in the LAN to build a secure and flexible perimeter similar to what has been in place for years at the LAN/WAN boundary.

However, the whole concept of distributing intelligence in the campus LAN is counter-intuitive to IT personnel who have spent a good part of the last ten years consolidating servers, application intelligence and data into data centers where management is more efficient, physical security is easier to enforce, and assets can be utilized more efficiently.

IT managers have a choice of deploying these new breed of service elements using one of the three options:
Upgrade the wiring closet edge switches infrastructure
Cut a wire behind the wiring closet edge switch and insert the service elements in a chain
Deploy the service elements using a network tap, or using a spanning port or mirror port on the wiring closet edge switch.
   All of these options have disadvantages associated with them. It is important to note that while the value of these service elements is highly appreciated, improvements are desired in the deployment options of these service elements.

Traditionally, physical collapsed backbone technology has been deployed by implementing a backbone at a centralized location and by connecting all subnetworks and end-stations to it. This physical collapsed backbone is traditionally implemented in a backplane of a single switch. Such architecture provides advantages in terms of easier control, improved manageability and enhanced security. However, this network topology requires longer cabling to be run from each end-station to the physical collapsed backbone switch.

A conventional method described in U.S. Pat. No. 5,764,895 includes a one-chip local area network (LAN) device comprising more than one LAN ports connected over a high-speed bus to a switch engine. It presents a block diagram of a high-bandwidth collapsed backbone switch that combines multiple LAN devices, an ASIC, a host interface and a microcomputer on a single high bandwidth bus.

Another conventional method described in U.S. Pat. No. 5,426,637 includes interconnection of several widely separated LANs using single WAN backbone—using network level facilities to establish connection through WAN and create connection table entry points at access points allowing subsequent frames to pass without network level operation. Clearly, this prior art is focused on creating a physical backbone in WAN for various LAN segments

Another conventional method described in U.S. Pat. No. 5,655,140 includes an FDDI concentrator acting as collapsed FDDI ring (“collapsed backbone”), which deals with a physical collapsed backbone with FDDI ring.

U.S. published patent application No. 2005/0111445 describes a router for use in telecommunication network that has one layer module with layer routing engine to forward data packet through switch fabric to another module using layer address related with packet. Clearly, this collapsed backbone is physically implemented in a router.

### SUMMARY OF THE DESCRIPTION

A system and method for implementing an overlay network architecture called a Virtual Collapsed Backbone (VCB) are described herein. In one embodiment, a VCB provides a framework for consolidating campus network service elements in a centralized fashion, instead of distributing them at the edges of the campus network. End stations or hosts create tunnels to a new type of network device called Network Junction Point (NJP) and the NJP steers the traffic through service elements selected based on the traffic steering policy.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows an exemplary campus network, and provides an illustration of the tunnels used in creation of virtual collapsed backbone, the virtual services network (VSN) used to connect service elements, and the network junction point (NJP).

FIG. 2 is an operation flow diagram that explains the operation of virtual collapsed backbone.

FIG. 3 is an operational flow diagram that illustrates the operation of a network junction point.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

Accordingly, a framework is created that allows better deployment alternative for the network service elements in an enterprise network. In one embodiment, techniques described herein aim at deploying the service elements in a central location in the same campus, instead of placing them at various places at the edge of campus network. In addition, service elements deployed at the edge network (e.g. near wiring closet switches) are typically significantly underutilized. They are rated at the speed of the wire, rather than at the actual average bandwidth transiting through them. By consolidating these service elements in a centralized location, these devices can be shared across traffic from various sources. This leads to better utilization of the service elements. Further, centralized deployment leads to ease of management and physical security of the service elements. The devices are placed in physically secure areas such as data centers or server rooms. IT managers have easy access to these devices for management and maintenance.

Briefly stated, an embodiment of the invention is directed to a system and method for consolidating the service elements in a centralized fashion in the campus network. An embodiment of the invention provides a framework for this better deployment option. In one embodiment, a new device, termed Network Junction Point or NJP, is defined in this application. This device is placed in the same campus network. This campus local area network is configured to perform at least some of the following actions:

### End Stations:

Host end station to server direction:
Generating traffic directed to the appropriate destination.
Directing the traffic to NJP using a tunnel based on a standard protocol such as PPTP, L2TP, IPSec, etc.

Server to host end station direction:
Receiving tunneled traffic from NJP.
Terminating the tunnels in the received traffic, and presenting the inner payload to appropriate internal application.

### NJP:

Host end station to server direction:
Receiving tunneled traffic from end stations
Terminating the tunnel and de-capsulating the tunnel headers from the received traffic.
Performing a configured policy lookup to select the service elements the traffic needs to traverse through.
Steering the traffic through the selected service elements.
Performing normal Layer-2/Layer-3 forwarding functions to direct the traffic to its intended destination.

Server to host end station direction:
Performing ARP proxy such that the traffic destined to end stations is directed to NJP by the rest of the network.
Performing a configured policy lookup to select the service elements the traffic needs to traverse through.
Steering the traffic through the selected service elements.
Encapsulating the traffic in a tunnel for sending it the end station.
Performing normal Layer-2/Layer-3 forwarding functions to direct the tunneled traffic to the end station.

In one embodiment, it is directed to a method of tunneling the traffic generated by the end stations and directing the tunnels to the NJP. The traffic is sent to NJP over the normal campus local area network (LAN). Similarly, for the return traffic, this invention is directed to a method of stripping the tunnel and presenting the traffic to appropriate upper layer protocols or applications.

In another embodiment, it is directed to a method of receiving the tunneled traffic at the NJP, de-capsulating the tunnel, and presenting the traffic for further processing. Similarly, for the return traffic, it is directed to a method of generating a tunnel by encapsulating the traffic, and forwarding the traffic to the host end station.

In yet another aspect, an embodiment of the invention is aimed at creating, updating and maintaining a policy table that is used to select appropriate service elements that the traffic needs to traverse through. This table is configured using the management interface to NJP.

In still another aspect, an embodiment of the invention is directed to a method of steering the traffic through the selected service using common Layer-2/Layer-3 based forwarding techniques. In case of inline service elements the traffic may be received back from the service elements for further processing.

In one more aspect, an embodiment of the invention is directed to a method of forwarding the traffic to its intended destination as encoded in the packet by the source end station, using normal Layer-2/Layer-3 based forwarding techniques deployed in the campus local area network.

### DEFINITIONS

The definitions in this section apply to this document, unless the context clearly indicates otherwise. The phrase “this document” means the specification, claims, and abstract of this application.

“Including” and its variants mean including but not limited to. Thus, a list including A is not precluded from including B.

A “Layer-2/Layer-3 network” means a campus network of Layer-2 or Layer-3 devices that interconnects a plurality of computing devices using a combination of Layer-2 network elements such as Ethernet bridges or Ethernet switches, and Layer-3 devices such as IP routers. Further, this network is capable of performing Layer-2 bridging/switching services, MAC-address based forwarding functions. IP address based forwarding functions, maintenance of routing and forwarding databases, etc. The term “Layer-2/Layer-3 forwarding” means forwarding performed by network elements in such a network. The term “Edge network” refers to the edge of this network where end stations connect to the network, and which is typically implemented by placing Layer-2/Layer-3 switches in the wiring closets across the physical topology of the network.

A “service element” refers to a network device that adds value to the network operation. Examples of such devices include firewall, intrusion detection and prevention systems (IDPS), Malware/spyware protection devices, peer to peer traffic management, identity management, compliance monitoring appliances, etc. The term “SE” refers to a service element.

The term “Virtual Services Network” refers to a consolidated centralized network that is used to connect various service elements to NJP. The term “VSN” refers to a virtual services network.

The term “tunnel” refers to a encapsulation/de-capsulation mechanism based on standard protocols such as point to point tunneling protocol (PPTP), layer-2 tunneling protocol (L2TP), or IPSec.

The term “Virtual Collapsed Backbone” refers to the reference framework architecture that consolidates the service elements in a centralized fashion. The term “VCB” refers to a virtual collapsed backbone.

The term “Network Junction Point” refers to a device in the campus network that handles tunnels towards the end stations, performs a policy lookup to select service elements for the traffic to pass through, steers the traffic through selected service elements, and performs Layer-2/Layer-3 based forwarding based on the intended destination address. The term “NJP” refers to a network junction point.

The term “End station” refers to the any computer system such as a personal workstation, personal computing device, laptop computer, host computer, etc.

Referring to the drawings, like numbers indicate like parts throughout the figures and this document.

The meaning of “a,” “an,” and “the” include plural references. The meaning of “in” includes “in” and “on.”

Additionally, a reference to the singular includes a reference to the plural unless otherwise stated or is inconsistent with the disclosure herein.

Definitions of terms are also found throughout this document. These definitions need not be introduced by using “means” or “refers” to language and may be introduced by example and/or function performed. Such definitions will also apply to this document, unless the context clearly indicates otherwise.

### Illustrative Environments

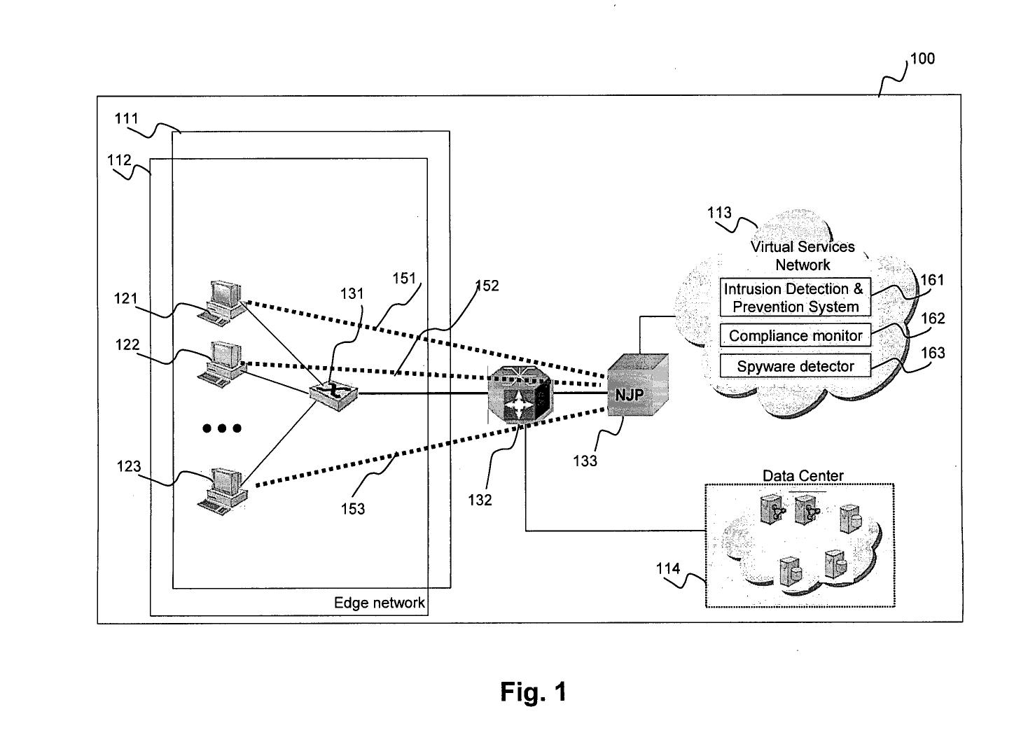

FIG. 1 shows an exemplary network 100 comprising campus edge networks 111 and 112, campus core switch 132, NJP 133, virtual services network (VSN) 113, and data center 114. A campus edge network may contain a plurality of end stations 121, 122, 123, wiring closet switches 131, and other network elements such as hubs, bridges, switches, routers, gateways, etc. NJP 133 is also placed in the campus network, but is not connected inline with the campus edge switches. It will be appreciated that the campus network may include many more components than those shown in FIG. 1. However, the components shown are sufficient to disclose an illustrative environment for practicing embodiments of the present invention.

Further, FIG. 1 illustrates the basic operation of virtual collapsed backbone. End stations or hosts 121, 122 and 123 create and maintain tunnels 151, 152 and 153 respectively. These tunnels are addressed to the NJP and they terminate on the NJP. As shown in FIG. 1, service elements are consolidated and deployed in a centralized fashion in the virtual services network 113. Exemplary service elements include intrusion detection and prevention system 161, a compliance monitor 162 and a spyware detector 163. The virtual services network 113 is connected to the NJP 133.

Traffic from host end stations 121, 122, and 123 travels to the NJP 133 over the tunnels 151, 152, and 153 respectively. NJP 133 steers this traffic through selected set of service elements connected in virtual services network 113. After the traffic passes through the selected service elements, traffic is forwarded to its final destination.

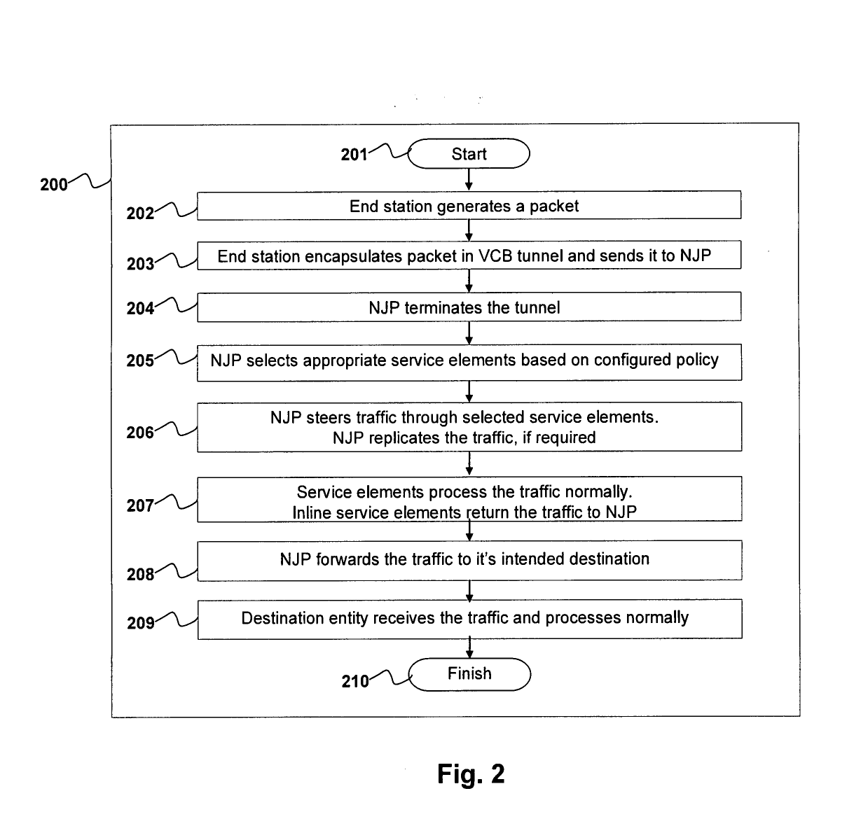

FIG. 2 is an operational flow diagram 200 illustrating a process of handling packets in a VCB environment. Process 200 may be implemented in a system with different components than those contained in exemplary network illustrated in FIG. 1.

Moving from a start block 201, the process goes to block 202 where the end station generates a data packet. End station encapsulates this packet in a VCB tunnel and it forwards the packet towards NJP in block 203. Process 200 continues at block 204 where the NJP receives this tunneled packet, terminates the tunnel, and de-capsulates the data packet. Moving to block 205, NJP performs a policy lookup to select an appropriate set of service elements that need to see this traffic. As shown in block 206, NJP then steers the traffic through selected service elements using normal Layer-2/Layer-3 forwarding techniques. If the configured policy calls for replication, then NJP also replicates the packets and forwards copies of the original data packet to the service elements. Process 200 then goes to block 207 where the service elements process the traffic normally. Inline service elements return the traffic back to NJP. Moving to block 208, NJP then forwards the packet to its intended destination. As shown in block 209, the destination entity receives the traffic and processes it normally. Then process 200 ends at block 210.

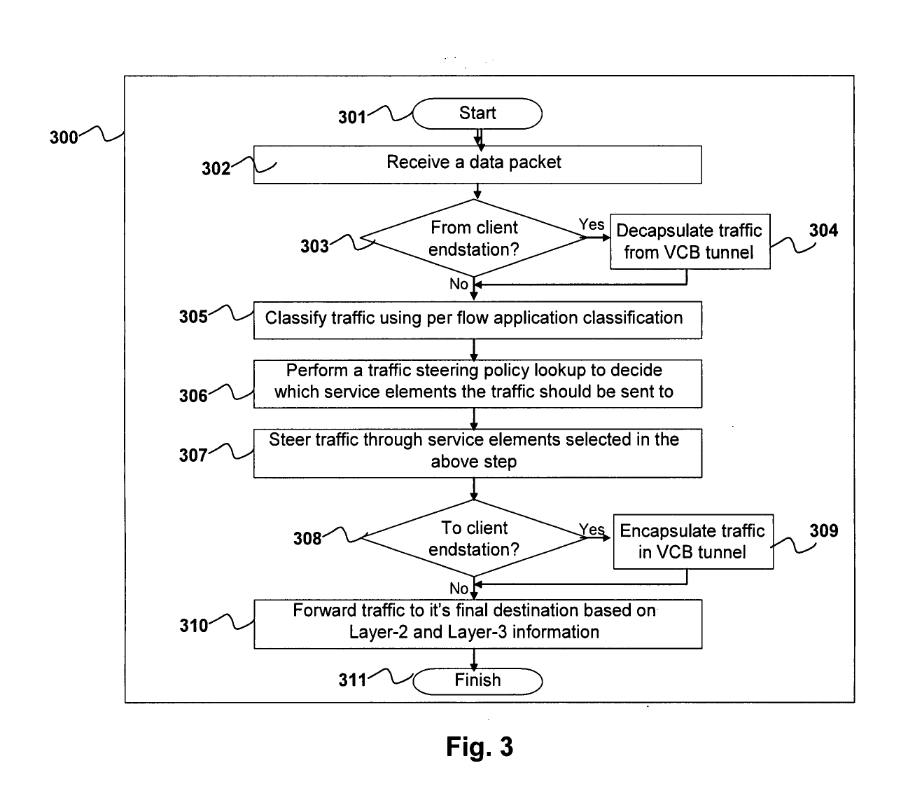

FIG. 3 is an operational flow diagram illustrating a process of handling packets in a NJP. Process 300 may be implemented in a system with different components than those contained in exemplary network illustrated in FIG. 1.

Starting from block 301, the process 300 goes to block 302 where NJP receives a data packet. NJP then evaluates the source of the packet at block 303. If the packet was originated from a client end station, then the process moves to block 304 where NJP de-capsulates the tunnel and the process moves to block 305. Otherwise, the process 300 moves to block 305 directly. NJP classifies the packet using per flow application classification at block 305. As the process 300 moves to block 306, NJP performs a traffic steering policy lookup to decide which service elements the packet needs to be sent to. As shown in block 307, NJP steers the packet through the set of service elements selected in block 306.

NJP then evaluates the destination of the packet at block 308. If the packet is destined to a client host end station, then the process moves to block 309 where NJP encapsulates the packet in tunnel and the process moves to block 310. Otherwise, the process 300 moves to block 310 directly. At block 310, NJP forwards the packet to its intended destination by performing a normal Layer-2/Layer-3 forwarding lookup. Process 300 then terminates at block 311. Other operations may also be performed.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, comprising:
in response to a first network traffic received from a first host end station by a network junction point via a first tunnel over a network, terminating the first tunnel and de-capsulating headers from the first network traffic;
performing a policy lookup to select one or more service elements through which the first network traffic needs to traverse to provide the same services as if the service elements were placed inline at the campus network wiring closet edge switch; and
steering the first network traffic through the selected service elements.

2. The method of claim 1, further comprising performing normal layer-2 and/or layer-3 forwarding operations to direct the first network traffic to a destination of the first network traffic.

3. The method of claim 2, further comprising:
in response to a second network traffic destined to a second end station, performing an ARP (address resolution protocol) proxy operation such that the second network traffic is directed to an NJP by a remainder of the network;
performing a policy lookup to select one or more service elements through which the second network traffic needs to traverse; and
steering the second network traffic through the selected service elements.

4. The method of claim 3, further comprising:
encapsulating the second network traffic in a second tunnel for sending the second network traffic to the second host end station; and
performing normal layer-2 and/or layer-3 forwarding operations to direct the tunneled traffic to the second host end station.

5. A computer-implemented method, comprising:
in response to a network traffic destined to an end station over a network, performing an ARP (address resolution protocol) proxy operation such that the network traffic is directed to an NJP by a remainder of the network effectively making the NJP appear as the campus network wiring closet edge switch;
performing a policy lookup to select one or more service elements through which the network traffic needs to traverse; and
steering the network traffic through the selected service elements.

6. The method of claim 5, further comprising:
encapsulating the network traffic in a tunnel for sending the network traffic to the host end station; and
performing normal layer-2 and/or layer-3 forwarding operations to direct the tunneled traffic to the host end station.
